(19) United States
(12) Patent Application Publication
(10) Pub. No.: US 2024/0186621 A1
(43) Pub. Date: Jun. 6, 2024

(54) SYSTEMS AND METHODS FOR COOLING A BATTERY PACK

(71) Applicant: Atlis Motor Vehicles Inc., Tempe, AZ (US)

(72) Inventor: Christopher Largent, Tempe, AZ (US)

(21) Appl. No.: 18/440,602

(22) Filed: Feb. 13, 2024

Related U.S. Application Data
(60) Provisional application No. 63/445,034, filed on Feb. 13, 2023.

(51) Int. Cl. H01M 10/663; B60L 50/60; B60L 58/26; H01M 10/613; H01M 10/625; H01M 10/63; H01M 10/6569; H01M 50/204; H01M 50/507

(52) U.S. Cl. CPC H01M 10/663; B60L 50/60; B60L 58/26; H01M 10/613; H01M 10/625; H01M 10/63; H01M 10/6569; H01M 50/204; H01M 50/507; H01M 2220/20

(57) ABSTRACT

Implementations of a method of cooling a battery pack may include including a controller coupled with a plurality of battery cells; providing a container enclosing only an anode terminal and a cathode terminal of each battery cell, the container sealed against exterior surfaces of the plurality of battery cells. The method may include monitoring an activity of an electric vehicle using the controller and when the activity of the electrical vehicle is below a first threshold, the controller does not activate a heat removal system in fluid communication with the container; when the activity of the electrical vehicle is above the first threshold but below a second threshold, the controller activates the heat removal system in a low throughput mode; and when the activity of the electrical vehicle is above the second threshold, the controller activates the heat removal system in a high throughput mode.

### CROSS REFERENCE TO RELATED APPLICATIONS

This document claims the benefit of the filing date of U.S. Provisional Patent Application 63/445,034, entitled “Systems and Methods For Cooling a Battery Pack” to Christopher Largen which was filed on Feb. 13, 2023, the disclosure of which is hereby incorporated entirely herein by reference.

### BACKGROUND

### 1. Technical Field

Aspects of this document relate generally to battery packs. More specific implementations involve systems and methods for cooling battery packs.

### 2. Background

Electric vehicles have been devised that permit transport of people and goods. Various kinds of electric vehicles include automobiles, trucks, watercraft, and even aircraft. The use of electricity rather than fossil fuels can reduce the environmental impact of operating an electric vehicle when compared to an equivalent fossil fuel powered vehicle.

### SUMMARY

Implementations of a cooling system for a battery pack may include a battery pack including a plurality of battery cells, each battery cell of the plurality of battery cells including an anode terminal and a cathode terminal and at least two busbars coupled to the anode terminal and the cathode terminal of each battery cell of the plurality of battery cells to form one of a parallel connection between each battery cell of the plurality of battery cells or a serial connection between each battery cell of the plurality of battery cells. The system may include a container enclosing only the anode terminal and the cathode terminal of each battery cell of the plurality of battery cells and the at least two busbars, the container forming a channel with an inlet and an outlet and the container sealed against exterior surfaces of the plurality of battery cells. The system may include a tube passing through the container and including a plurality of openings spaced adjacent to the at least two busbars and spaced adjacent to one of the anode terminal, the cathode terminal, or both the anode terminal and the cathode terminal of each battery cell of the plurality of battery cells; and a heat removal system in fluid communication with the tube.

Implementations of a cooling system for a battery pack may include one, all, or any of the following:

The cooling system may include a pump in fluid communication with the tube and with the heat removal system.

The cooling system may include a medium cooled by the heat removal system and directed by the plurality of openings against the at least two busbars and the anode terminal and cathode terminal of each battery cell of the plurality of battery cells.

Medium heated by the at least two busbars and the anode terminal and cathode terminal of each battery cell of the plurality of battery cells may pass out of the outlet of the channel of the container to the heat removal system.

The controller may be operably coupled with the battery pack and with the heat removal system.

When an activity of an electric vehicle associated with the battery pack may be below a threshold, the controller does not activate the heat removal system.

When an activity of an electric vehicle associated with the battery pack may be above a threshold, the controller activates the heat removal system.

Implementations of a cooling system for a battery pack may include a battery pack including a plurality of battery cells, each battery cell of the plurality of battery cells including an anode terminal and a cathode terminal and at least two busbars coupled to the anode terminal and the cathode terminal of each battery cell of the plurality of battery cells to form one of a parallel connection between each battery cell of the plurality of battery cells or a serial connection between each battery cell of the plurality of battery cells. The system may include a container enclosing only the anode terminal and the cathode terminal of each battery cell of the plurality of battery cells and the at least two busbars, the container forming a channel with an inlet and an outlet, the container including a plurality of nozzles spaced adjacent to the at least two busbars and spaced adjacent to one of the anode terminal, the cathode terminal, or both the anode terminal and the cathode terminal of each battery cell of the plurality of battery cells. The system may include a tube coupled to an exterior surface of the container and to the outlet of the container; and a heat removal system in fluid communication with the tube.

Implementations of a cooling system for a battery pack may include one, all, or any of the following:

The cooling system may include a pump in fluid communication with the tube and with the heat removal system.

The cooling system may include a medium cooled by the heat removal system and directed by the plurality of nozzles against the at least two busbars and the anode terminal and cathode terminal of each battery cell of the plurality of battery cells.

The medium may be in two phases in the container.

The tube may receive heated medium from the outlet of the container and directs it to the heat removal system.

The inlet of the container may receive cooled medium from the heat removal system.

The nozzles may be located on two or more sides of the container.

The nozzles may be located on only one side of the container.

Implementations of a method of cooling a battery pack may include providing a battery pack including a controller coupled with a plurality of battery cells, each battery cell of the plurality of battery cells including an anode terminal and a cathode terminal; providing a container enclosing only the anode terminal and the cathode terminal of each battery cell of the plurality of battery cells, the container forming a channel with an inlet and an outlet and the container sealed against exterior surfaces of the plurality of battery cells; and monitoring an activity of an electric vehicle coupled with the battery pack using the controller. The method may include when the activity of the electrical vehicle may be below a first threshold, the controller does not activate a heat removal system in fluid communication with the container; when the activity of the electrical vehicle may be above the first threshold but below a second threshold, the controller activates the heat removal system in a low throughput mode; and when the activity of the electrical vehicle may be above the second threshold, the controller activates the heat removal system in a high throughput mode.

Implementations of a method of cooling a battery pack may include one, all, or any of the following:

The system may include a medium cooled by the heat removal system.

When the activity of the electrical vehicle may be below the first threshold, the medium passively flows in the container.

The system may include a pump in fluid communication with the container and with the heat removal system.

When the activity of the electrical vehicle is be below a first threshold, the controller may not activate the pump; when the activity of the electrical vehicle is above the first threshold but below a second threshold, the controller may activate the pump in a low throughput mode; and when the activity of the electrical vehicle is above the second threshold, the controller may activate the pump a high throughput mode.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a block diagram of a implementation of a system for cooling a battery pack in accordance with the present disclosure;

FIG. 2 is a perspective view of an implementation of a battery cell;

FIG. 3 is a perspective view of an implementation of a battery pack;

FIG. 4 is a side view of an implementation of a cooling system coupled with a battery pack;

FIG. 5 is a top view of the cooling system implementation of FIG. 4 with the container portion closed;

FIG. 6 is a top view of the cooling system implementation of FIG. 4 with the container portion open;

FIG. 7 is a side cross-sectional view of the cooling system of FIG. 6 taken at sectional line 7-7;

FIG. 8 is a side cross-sectional view of the cooling system of FIG. 6 taken at sectional line 8-8;

FIG. 9 is a cross-sectional view of another implementation of a cooling system coupled with a battery pack;

FIG. 10 is a cross-sectional view of another implementation of a cooling system coupled with a battery pack; and

FIG. 11 is a cross-sectional view of another implementation of a cooling system coupled with a battery pack.

### DESCRIPTION

This disclosure, its aspects and implementations, are not limited to the specific components, assembly procedures or method elements disclosed herein. Many additional components, assembly procedures and/or method elements known in the art consistent with the intended battery pack cooling systems and related methods will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such battery pack cooling systems, and implementing components and methods, consistent with the intended operation and methods.

Various battery pack cooling systems submerge or surround the battery cells of the battery pack entirely to cool the battery cells, terminals and busbars of the battery pack. In contrast with this approach, the various implementations of cooling systems for battery packs disclosed herein seal only the terminals and the busbars of the battery cells of the battery pack are sealed in a container. As a result, the bodies (e.g., housings) of the battery cells themselves are not positioned inside the container. The container holds a medium (a liquid or gas) that cools the terminals and the busbars of the battery cells. As the medium removes heat from the terminals and the busbars, heat is removed from the components of the battery cells (electrodes, busbars, chemical solution, housing, etc.).

In various implementations, the container includes one or more inlets for receiving the cooled medium. In various implementations, the container includes one or more channels for transporting the cooled medium inside the container. In various implementations, te container includes one or more tubes with openings which are positioned over and/or proximate to the terminals and busbars of the battery cells of the battery pack. In particular implementations, the tube(s) receive the cooled medium from the one or more channels. The cooled medium exits the openings in the tube(s) to come into contact with the busbars and/or terminals of the battery cells. In particular implementations, the cooled medium may forcefully exit the openings to create improved convective heat transport conditions with the busbars and/or the terminals to facilitate heat transfer from the busbars and/or the terminals to the medium, resulting in heating of the medium. The medium, after it has extracted heat from the busbars and/or the terminals, is referred to herein as a heated medium. In various implementations, the heated medium exits the container via an outlet. The heated medium is transported to an heat removal system (HVAC system) in fluid communication with the container where it is cooled for reintroduction into the inlet of the container. In a particular implementation, the cooling system is a closed system.

Because the container of the cooling system implementations disclosed herein enclose only the busbars and the terminals of the battery, the volume of the container is significantly less than a container that encloses the entire battery cells including the busbars and the terminals.

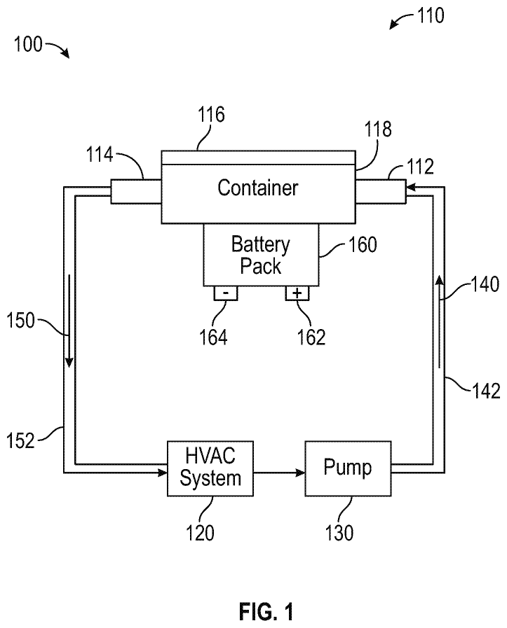

Referring to FIG. 1, a system for cooling a battery pack by cooling the busbars and the terminals of the battery cells of the battery pack is illustrated. The system illustrated in FIG. 1 includes the battery pack, a container, a heat removal system (HVAC system), a pump, and a medium adapted to transfer heat. As illustrated, the container encloses just the terminals and busbars of the battery cells and does not enclose the entire battery pack or the full housings of the battery cells of the battery pack. The container includes an inlet and an outlet. The heat removal system cools (removes heat from) the medium. In this implementation, the pump moves the cooled medium into the inlet of the container. Inside the container, the cooled medium comes into contact with the busbars and/or the terminals of the battery cells. The cooled medium may also come into contact with the top of the housing of the battery cells of the battery pack or other portion thereof.

As the cooled medium extracts heat from the busbars and/or the terminals of the battery cells of the battery pack, since the busbars and terminals are thermally coupled with the electrodes, the chemical, and the housing of the battery cells, the extraction of heat from the busbars and/or the terminals extracts heat from the entire battery cell of each battery cell of the battery pack. As the medium extracts heat from the busbars and/or the terminals, its temperature increases. In various implementations, in response to cooled medium being pumped into the inlet of the container, heated medium flows out of the outlet of the container. The heated medium returns to (circulates) to the heat removal system which is in fluid communication with the container. The heated medium is then cooled by the heat removal system and, in this implementation, moved by the pump into the inlet of the container. In this implementation, the system for cooling the battery pack is a closed system.

In various method implementations, the cooling system is attached to a battery pack installed in an electrical vehicle (automobile, truck, aircraft, watercraft, etc.). During operation of the electric vehicle, in particular system and method implementations, while the electric vehicle is not drawing a large current from the battery pack (as when the electrical vehicle is in a low activity condition such as, by non-limiting example, idling, at a speed below a certain limit, or in a stable cruising driving condition (an activity below a first threshold value for current draw), a controller coupled to the battery pack and to the pump and/or heat removal system directs the pump and/or heat removal system to not operate because the medium present the cavity of the container is sufficient to maintain the temperature of or cool the battery cells of the battery pack using passive flow/circulation within the container. As the activity of the electric vehicle increases above the first threshold value but below a second threshold value for current draw, as the current from the battery increases, the controller directs the heat removal system and/or the pump to start operation in a low capacity (low throughput, low volume) mode. As the activity of the electric vehicle further increases above the second threshold value for current draw, the controller directs the heat removal system and/or pump in the pump operates in an increasingly higher capacity (high throughput) mode to provide sufficient cooled medium to reduce and/or maintain the temperature of the battery pack.

Similarly, while the battery is being charged, the heat removal system and the pump operate to provide the cooled medium in a volume and at a temperature sufficient to maintain the temperature of the battery pack. In various method implementations, where charging is being carried out below a threshold intensity/current level, the heat removal system and/or the pump operate in a low throughput mode. Where the charging is being carried out above a threshold intensity/current level, the heat removal system and/or the pump operate in a high throughput mode.

In systems where a pump is not used and only a heat removal system is used to move medium through the system for cooling, the controller interacts only with the heat removal system and battery pack. In systems where a pump is included, the controller interacts with both the heat removal system and the battery pack. In some system implementations, where the heat removal system is capable of removing heat passively even when a compressor or pump of the system or the pump is not operating as in a radiator system where changes in the density of the medium occur due to changes in temperature of the medium, the controller can leave the active components of the heat removal system and/or the pump off when the activity of the electrical vehicle is detected to be below the first threshold value for current draw.

Referring to FIG. 1 once again, an implementation of a cooling system 100 includes heat removal system (HVAC system) 120, pump 130, cooled medium conduit 142, battery pack 160, container 110, and heated medium conduit 152. As illustrated, the battery pack 160 includes an anode terminal 162 and a cathode terminal 164 which here are illustrated as not being inside the container for purposes of illustration, but would be included inside container 110 as previously described.

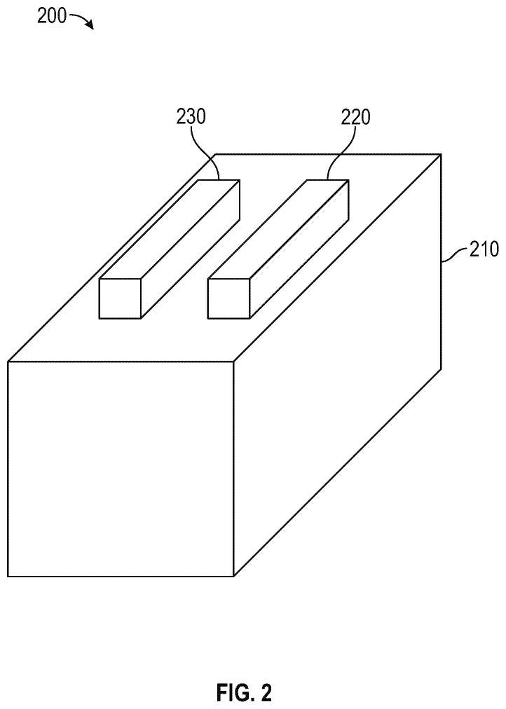

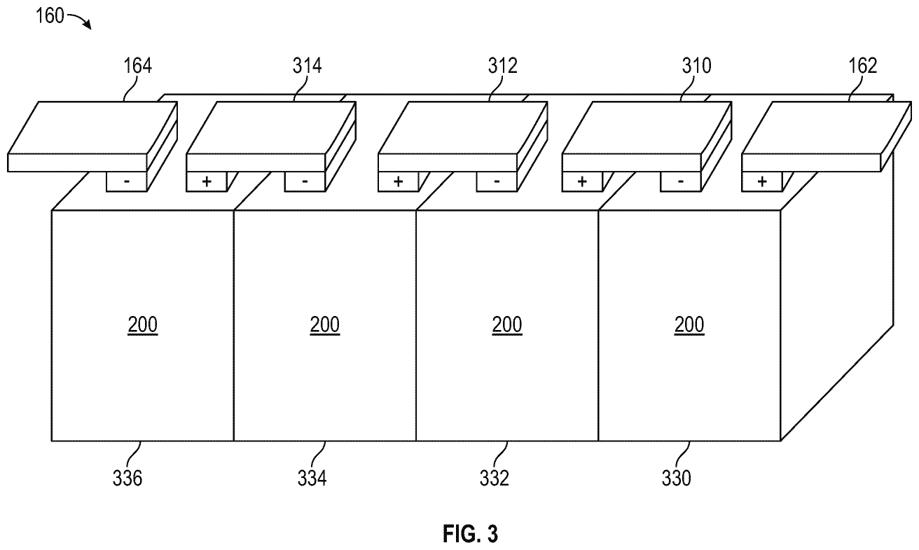

Referring to FIG. 2, an implementation of a battery cell 200 is illustrated which is one of a plurality of similar cells in the battery pack. As illustrated, the battery cell includes an anode terminal 220, a cathode terminal 230 and a housing 210. The housing 210 holds the electrodes and the chemicals needed to perform the chemical reaction that charges and discharges the battery cell 200 to provide electricity to the electric vehicle at the design current and voltage. The anode terminal 220 electrically and thermally connects to the anode electrodes of the electric vehicle (not shown). The cathode terminal 230 electrically and thermally connects to the cathode electrodes of the electric vehicle (not shown). The anode terminal 220 and the cathode terminal 230 may be positioned at any location on the housing 210 (e.g., top, bottom, top and bottom, sides) depending on the cell design. The plurality of battery cells are physically and electrically coupled to each other in series or in parallel to form the battery pack 160 that delivers a particular design current at a design voltage. Referring to FIG. 3, a plurality of battery cells 200 are coupled together in series to form the battery pack 160. As illustrated, busbars 310 are used to connect the terminals of the battery cells 200 sequentially, positive to negative, in series. The busbars 310 can also be used to connect the terminals in parallel.

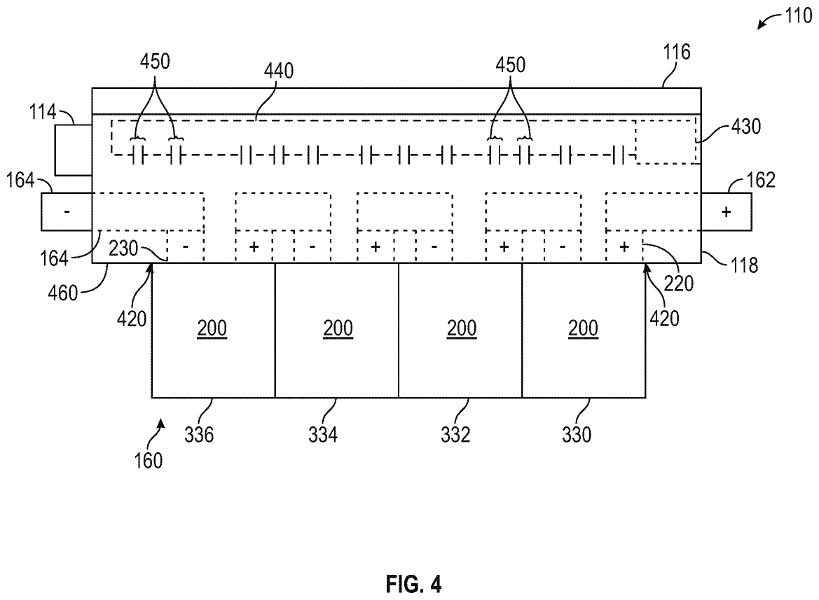

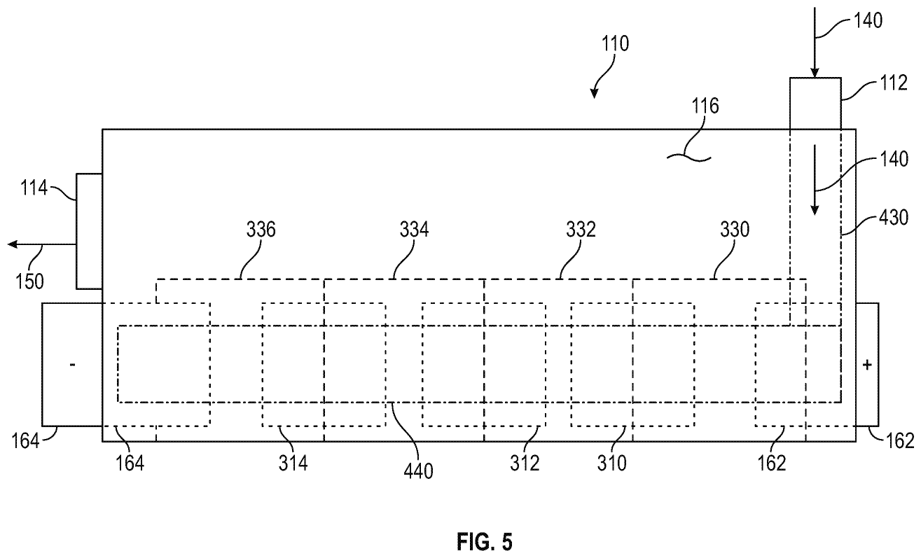

Referring to FIG. 4, an side partial see-through implementation of a cooling system 110 coupled to a battery pack 160 is illustrated. As illustrated, housing 118 includes an inlet 112, outlet 114, and a lid/closure 116. In this implementation, the bottom 460 of the housing 118 contacts the top of the housing 210 of the battery cells 200 of the battery pack 160. The bottom 460 of the housing 118 seals with/forms a seal with/is sealed to the top of the housings 210 and/or the terminals 220 and 230 of the battery cells 200. A seal 420 may be included to form the seal between the bottom 460 of the container 110 and the top of the housings 210 or around the terminals 220 and 230. Referring to the top down partial see-through view of FIG. 5 with the lid/closure 116 in place, the busbars 310 and the terminals 220 and 230 are positioned in the cavity 610 of the container 110. The cavity 610 is configured to receive cooled medium 140 and to contain heated medium 150 until the heated medium 150 exits the outlet 114 of the container. As illustrated, in this implementation, the busbars 310 and the terminals 220 and 230 come into direct contact with the cooled medium 140, the heated medium 150, or a mixture of the cooled medium 140 and the heated medium 150 inside the cavity 610 of the container 110. This facilitates both conductive and convective heat transfer o the medium. While the busbars 310 and the terminals 220 and 230 are contact with the cooled medium 140, the heated medium 150 and/or the mixture, heat is transferred from the busbars 310 and/or the terminals 220 and 230 into the medium. The greatest transfer of heat occurs when the busbars 310 and the terminals 220 and 230 already in contact with the cooled medium 140 because the temperature gradient is highest. The heated medium 150 is then pushed/circulated out the outlet 114 of the container 110 to move (recirculate in a closed system) to the heat removal system 120 in fluid communication the housing. In this implementation, the cooling system 100 is a closed system.

In cooling system implementations where a pump is used, referring to FIGS. 1 and 5, the pump 130 provides the force needed to push the cooled medium 140 through the cooled medium conduit 142 into the inlet 112 of the container 110 and the heated medium 150 out the outlet 114 back to the heat removal system 120 via the heated medium conduit 152. In particular implementations, as the cooled medium 140 enters the inlet 112, the entering cooled medium 140 displaces the heated medium 150 inside the cavity 610 thereby pushing the heated medium 150 out the outlet 114 through the heated medium conduit 152 to the heat removal system 120. In other implementations, the pump 130 pushes the cooled medium 140 into the inlet 112, while another pump (not shown) pushes the heated medium out from the outlet 114. In some implementations, the pump may be integrated with the heat removal system or separate. In some implementations, the heat removal system itself works to move the medium through the cooling system without the use of any additional pumps.

In some implementations of the container 110, the lid/16 116 is integral with/integrally formed with the housing 118. In such implementations, the container 110 is formed around/coupled aground the terminals 220 and 230 through openings in the container 110. In another implementation, the lid/closure 116 may be integral with the housing 118; however, other portions of the container 110 may include one or more removable panels that provide access to the cavity 610 during manufacture. The lid/closure 116 and any removable panels are connected to the housing 118 of the container 110 in such a manner that the medium does not leak from the container 110.

In various implementations, as illustrated in FIGS. 4-5, the battery pack 160 includes a plurality of battery cells. Each battery cell 200 of the plurality includes one or more anode terminals 220, one or more cathode terminals 230 and a housing 210. The housing 210 contains the electrodes and the chemicals of the battery cell 200. The anode terminal 220 and the cathode terminal 230 connect to the housing and to the anode collectors and cathode collectors respectively held inside the housing 210.

In a particular implementation, the anode terminal 220 and the cathode terminal 230 are positioned on a top of the housing 210, as illustrated in FIG. 2. In other implementations, however, the anode terminal 220 is positioned on the top of the housing 210 while the cathode terminal 230 is positioned on a bottom of the housing 210.

In the implementation of the container 110 illustrated in FIGS. 4-8, the anode terminal 220 and the cathode terminal 230 of each battery 200 of the battery pack 160 are positioned on the top of the housing 210. As illustrated, the container 110 connects to the top of the housings 210 and/or around the terminals 220 and 230 in such a manner that the anode terminal 220 and the cathode terminal 230 are positioned at least partially in the interior of the cavity 610 of the container 110. The container 110 seals around/is sealed around the anode terminal 220, the cathode terminal 230 and/or the top of the housing 210 in such a manner that no medium inside the cavity 610 exits the container 110, yet a portion of the anode terminal 220 and the cathode terminal 230 that are positioned inside the cavity 610 come into contact with that the cooled medium 140, the heated medium 150 and/or a mixture of the cooled medium 140 and the heated medium 150. In various implementations medium is non-electrically conductive so that the anode terminal 220 and the cathode terminal 230 are not shorted out. For example, a medium that includes various perfluorotributylamines, hydrofluoroethers, fluoroketones, or any combination thereof could be used in various implementations.

In implementations of battery cells where the anode terminal 220 is positioned on the top of the housing 210 while the cathode terminal 230 is positioned on the bottom of the housing 210 a first container 110 encloses the anode terminals 220 while a second container 110 (not shown), that may be entirely separate from the first container 110, encloses the cathode terminals 230. The cooling system 100 may include one or more containers for enclosing the anode terminals 220 and the cathode terminals 230 of the battery cells 200 and/or the busbars of the battery pack 160 depending on the configuration of the battery cells.

Where two or more battery cells 200 are connected in series and/or in parallel with each other, a battery pack 160 is formed. Connecting the battery cells 200 in parallel enables the battery pack 160 provide a higher current. Connecting the battery cells 200 in series enables the battery pack 160 to provide current at a higher voltage. Busbars are used to connect the battery cells 200 to each other whether connected in parallel or in series.

Referring to FIG. 3, the battery pack 160 implementation includes four battery cells 200 which are connected to each other in series. The series connection is formed by connecting the busbars 310, 312 and 314 to the cathode terminal 230 of battery 330 and the anode terminal 220 of the battery 332, the cathode terminal 230 of battery 332 and the anode terminal 220 of the battery 334, and the cathode terminal 230 of battery 334 and the anode terminal 220 of the battery 336 respectively. The anode terminal 220 of battery 330 connects to the anode terminal 162 of the battery pack 160. The cathode terminal 230 of battery 336 connects to cathode terminal 164 of the battery pack 160. Current enters (during charging) and leaves (during discharging) the battery pack 160 via the anode terminal 162 and the cathode terminal 164.

In the container 110 implementation illustrated in FIGS. 4-8, the anode terminal 162 and the cathode terminal 164 are partially positioned inside the cavity 610 of the container 110. The housing 118 of the container 110 thus seals around the anode terminal 162 and the cathode terminal 164 so that a portion of the anode terminal 162 and the cathode terminal 164 are positioned outside of container 110 for connection to the electric vehicle.

In other implementations, the anode terminal 220 of the battery 330 functions as the anode terminal 162 and the cathode terminal 230 of the battery 336 functions as the cathode terminal 164. However, even in this implementation, at least a portion of the terminals 162 and 164 are positioned inside the container 110 to allow for cooling while still allowing for connection with the electrical vehicle.

Referring to FIG. 5, the container 110 implementation illustrated includes the inlet 112, the outlet 114, the lid 116, the housing 118, the cavity 610, a channel 430 and a tube 440. The channel 430 and the tube 440 are positioned in the cavity 610 of the container 110. The channel 430 connects to the inlet 112. The inlet 112 and the channel 430 receive the cooled medium 140 from the cooled medium conduit 142. The tube 440 connects to the channel 430. The tube 440 also receives the cooled medium 140 from the channel 430.

In other implementations, the container 110 includes one or more channels 430 and one or more tubes 440. Each of the channels 430 receive the cooled medium 140 from the inlet 112. Each of the tubes 440 receives the cooled medium 140 from one or more of the channels 430.

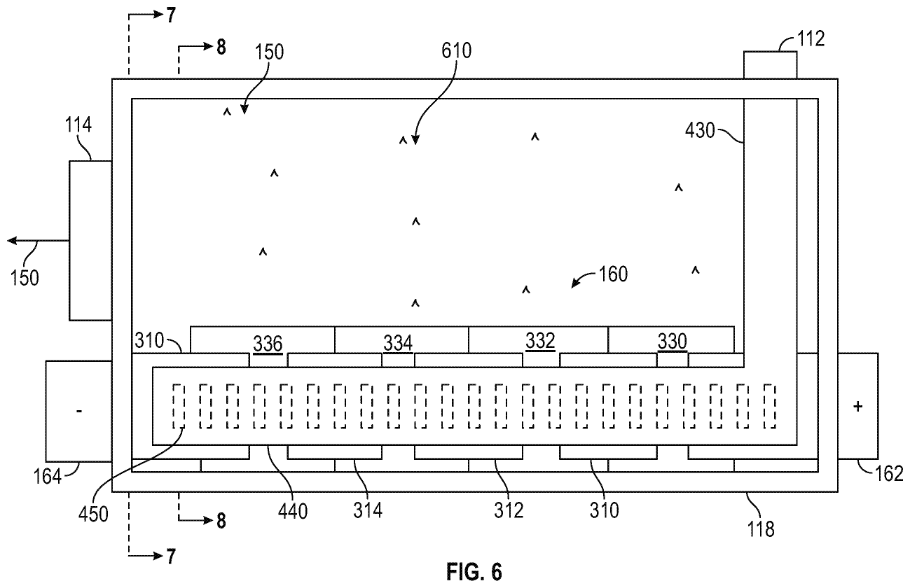

In the implementation illustrated in FIGS. 5 and 6, the tube is positioned above (over) the busbars 310-314, the terminals 220, 230 of the battery cells 330-336, and over at least a portion of the terminals 162 and 164. As illustrated, the tube 440 includes a plurality of openings 450. As the cooled medium 140 enters the tube 440 from the channel 430, the cooled medium 140 exits the plurality of openings 450 to release the cooled medium onto/directly at the busbars 310-314, the terminals 220, 230 and the exposed portions of the terminals 162 and 164. As a result, the cooled medium 140 comes into contact with the busbars 310-314, the terminals 220, 230 and the portions of the terminals 162 and 164. Contact of the cooled medium 140 with the busbars 310-314, the terminals 220, 230 and/or the portions of the terminals 162 and 164 transfers heat from the busbars 310-314, the terminals 220, 230 and/or the portions of the terminals 162 and 164 into the medium such that the cooled medium 140 to become the heated medium 150.

In various implementations, the busbars 310-314, the terminals 220, 230, the terminals 162 and 164, and the tube 440 are submerged in the heated medium 150. In the implementation illustrated in FIGS. 5-6, the cooled medium 140 is forced out of the openings 450 with sufficient pressure (force) and volume for the cooled medium 140 to displace the heated medium 150 so that the cooled medium 140 comes into direct contact with the busbars 310-314, the terminals 220, 230 and the terminals 162 and 164. In other implementations, at least a portion of the busbars 310-314 and/or the terminals 220, 230 are not submerged in the heated medium 150 so the cooled medium 140 exits the openings 452 to come into contact with only the submerged portion of the busbars 310-314, the terminals 220, 230, and/or the terminals 162 and 164.

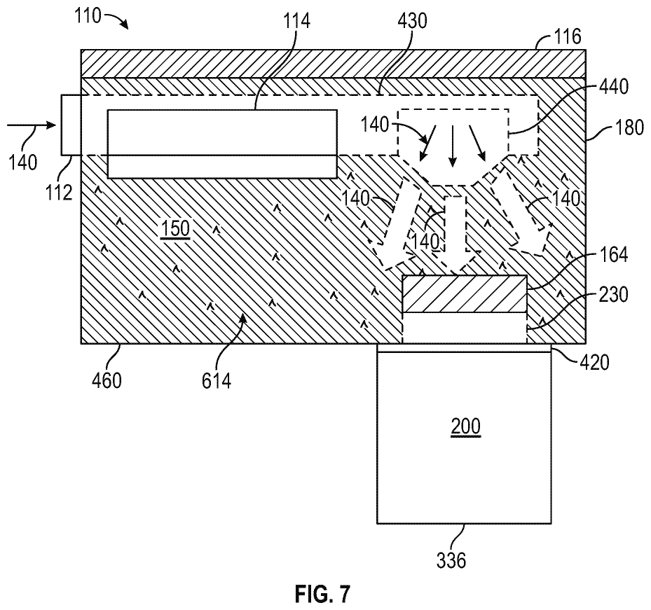

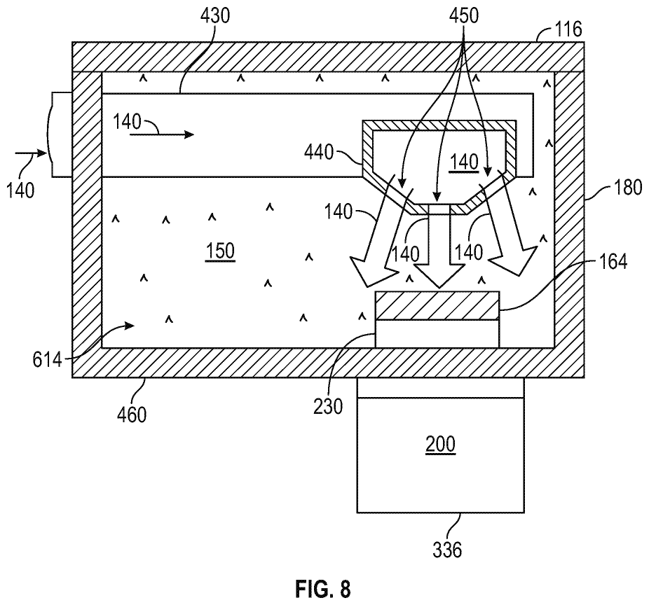

Referring to the cross-sectional views of FIGS. 7 and 8 taken along sectional lines 7-7 and 8-8 of FIG. 6, releasing the cooled medium 140 from the tube 440 via the openings 450 brings the cooled medium 140 into direct contact with the busbars 310-314, the terminals 220, 230, and/or the terminals 162 and 164, thereby enabling the cooled medium 140 to extract heat from the busbars 310-314, the terminals 220, 230 and/or the terminals 162 and 164. The cooled medium 140 that has extracted heat from the busbars 310-314, the terminals 220, 230, and/or the terminals 162 and 164 becomes the heated medium 150. The heated medium 150 may also extract heat from the busbars 310-314, the terminals 220, 230, and/or the terminals 162 and 164 depending on whether a sufficient temperature gradient exists. At some locations in the interior 610, the cooled medium 140 may mix with the heated medium 150. The mixture may also extract heat from the busbars 310-314, the terminals 220, 230, and/or the terminals 162 and 164. The mixture is also referred to herein as heated medium 150.

As illustrated in FIGS. 7 and 8, the openings 450 may include nozzles to set the direction of release of the cooled medium 140 from the tube 440. The nozzles may direct the flow toward one or more of the busbars 310-314, the terminals 220, 230, and/or the terminals 162 and 164. The openings 450 may include nozzles to direct the shape of the flow of cooled medium 140 exiting the tube 440. For example, a particular nozzle implementation may shape the flow of cooled medium 140 to be an angular (spray) shape or in other implementations a conical shape or rectangular cuboidal shape to come into contact with more surface area of the busbars 310-314, the terminals 220, 230, and/or the terminals 162 and 164. The nozzle may shape the flow of the cooled medium 140 to be a column to better penetrate the heated medium 150 that covers (submerges) the busbars 310-314, the terminals 220, 230, and/or the terminals 162 and 164 to bring the cooled medium 140 into contact with the busbars 310-314, the terminals 220, 230, and/or the terminals 162 and 164.

As the cooled medium 140 is pushed from the openings 450 in the tube 440, it displaces the heated medium 150 in the cavity 610 so that the heated medium 150 proximate to the outlet 114 is pushed out of the container 110 via the outlet 114. In other words, the pump 130 provides the cooled medium 140 at sufficient pressure and volume to displace the heated medium 150 out of the container 110 via the outlet 114 and through the heated medium conduit 152 to the heat removal system 120. In this implementation, the heated medium 150 is not actively removed from (sucked out of) the container 110. In other implementations, however, a second pump (not shown) connected to the outlet 114 may help, in addition to displacement caused by the pump 130, to draw the heated medium 150 out of the container 110, through the heated medium conduit 152 to the heat removal system 120.

In a particular implementation not directly illustrated herein, the battery pack 160 includes ninety battery cells 200. Each battery cell 200 includes an anode terminal 220 on the top of the housing 210 and a cathode terminal 230 on the bottom of the housing 210. The battery cells 200 are positioned proximate to each other in rows and columns with the position of the top of the housing and the bottom of the housing alternating so that the batteries may be connected in series. Because there are busbars and terminals on both the top and the bottom of the battery cells 200, a first container 110 encloses the busbars and battery cell terminals on the top of the battery pack 160 and a second container 110 contains the busbars and battery cell terminals on the bottom of the battery pack 160. In a particular implementation, the first container 110 is separate from the second container 110. The inlet 112 of the first container 110 and the inlet 112 of the second container 110 connect to the cooled medium conduit 142 while the outlets 114 of the two containers connected to the heated medium conduit 152. In another implementation, there are two or more containers 110 for the top and two or more containers 110 for the bottom of the battery pack 160. Each of the two mor more containers 110 includes an inlet 112 and an outlet 114 that connects to the cooled medium conduit 142 and the heated medium conduit 152 respectively.

Each of the containers 110 includes one or more channels 430. Each container 110 also includes one or more tubes 440. The tubes 440 are positioned proximate to one or more busbars 310-314 and/or terminals 220, 230. Each tube 440 includes a plurality of openings 450 that release the cooled medium 140 onto and proximate to the busbars 310-314 and/or the terminals 220, 230 to bring the cooled medium 140 into contact with the busbars 310-314 and/or the terminals 220, 230.

As with the other implementation disclosed herein, a pump 130 receives cool medium from a heat removal system 120. The pump 130 provides the cooled medium 140 to the inlets 112 of the containers 110 via the cooled medium conduit 142. The inlets 112 provide the cooled medium 140 to the channels 430 and the tubes 440. The cooled medium 140 exits the tubes 440 via the openings 450 onto the busbars 310-314 and/or terminals 220, 230. The cooled medium 140 that enters the cavity 610 of the containers 110 displaces (pushes out) the heated medium 150 from the containers 110 out the outlets 114 to the heated medium conduit 152 and back to the heat removal system.

Regardless of the number of containers 110, the battery cells 200, the cooled medium conduits 142 or the heated medium conduits 152, in various implementations, the cooling system 100 is closed so that no medium enters or leaves the cooling system 100.

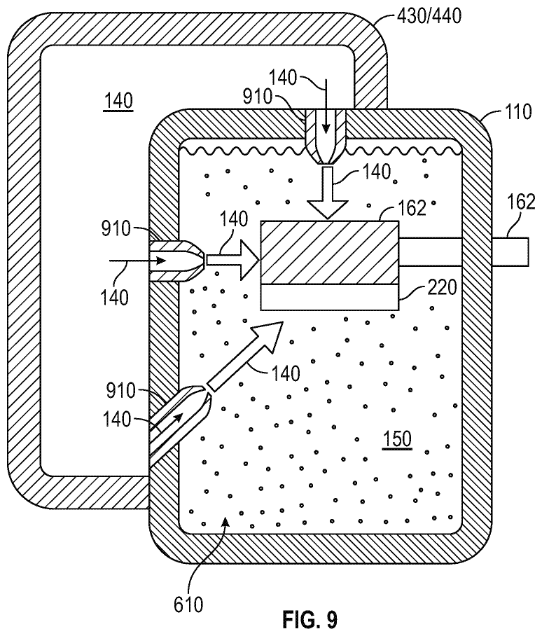

Referring to FIG. 9, the container 110 does not include the tube 440, but the tube is mounted/integrated externally to the container 110. In the implementation of FIG. 9, nozzles 910 are integrated into the sidewall of the housing 118 proximate to the busbars 310-314, the terminals 220, 230, and/or the terminals 162 and 164. The channel 430 or the tube 440 mounted to the exterior of the container 110 provides the cooled medium 142 the nozzles 910. The nozzles 910 provide the cooled medium 140 to the busbars 310-314, the terminals 220, 230, and/or the terminals 162 and 164 as a high-pressure jet of cooled medium 140. In this example embodiment, the busbars 310-314 and/or the terminals 220, 230 are submerged in the heated medium 150. In this implementation, the outlet of the container still receives the heated medium 150 while the inlet of the container actually is formed by the nozzles 910 themselves since the tube/channel 4440/430 are external to the container 110.

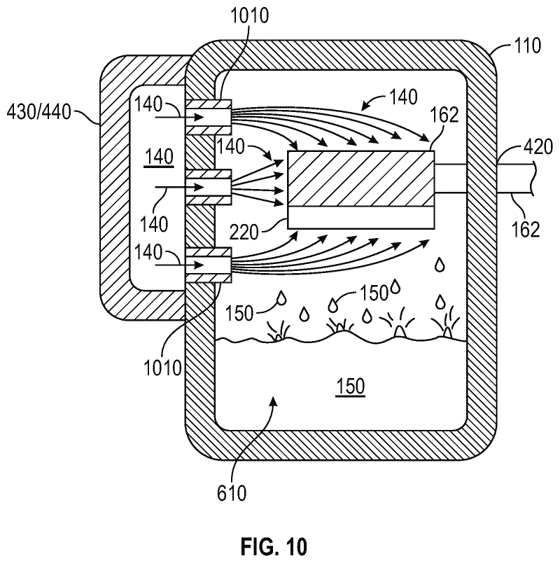

Referring to FIG. 10 a cross-sectional view of another cooling system implementation is illustrated. Here nozzles 1010 are integrated into the sidewall of housing 118 proximate to the busbars 310-314, the terminals 220, 230, and/or the terminals 162 and 164. Similar to the design of the implementation of FIG. 9, the channel 430 and/or the tube 440 provide the cooled medium 140 to the nozzles 1010 which form the inlet of the container housing 118. Since the medium in the implementation of FIG. 10 exists in two phases in the housing 118, the nozzles 1010 provide the liquid cooled medium 140 to the busbars 310-314, the terminals 220, 230, and/or the terminals 162 and 164 as a spray that covers the busbars 310-314, the terminals 220, 230, and/or the terminals 162 and 164. The spray of cooled medium 140 extracts heat from the busbars 310-314, the terminals 220, 230, and/or the terminals 162 and 164 and falls from the busbars 310-314, the terminals 220, 230, and/or the terminals 162 and 164 as heated medium 150. Some of the medium, however, is vaporized in the process and eventually condenses through the introduction of new cooled medium spray. The heated medium 150 pools in the cavity 610. In this example embodiment, the busbars 310-314, the terminals 220, 230, and/or the terminals 162 and 164 are not submerged in the heated medium 150. Because of the two-phase nature of this particular implementation, a second pump is used to extract the heated medium 150 from the housing 118/container 110.

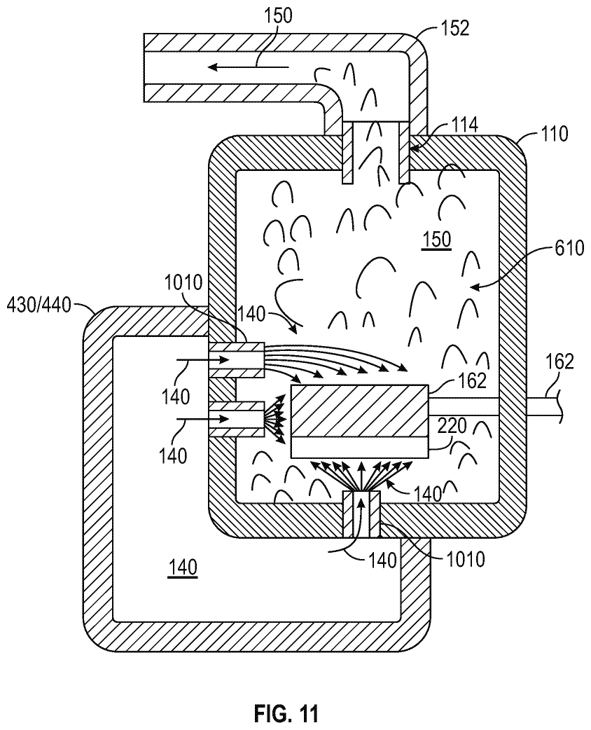

Referring to FIG. 11, another two-phase cooling system implementation is illustrated where nozzles 1010 are integrated into two sides of the housing 118 proximate to the busbars 310-314, the terminals 220, 230, and/or the terminals 162 and 164. The channel 430 and/or the tube 440 provide the cooled medium 140 to the nozzles 1010 which form the inlet of the housing 118. The nozzles 1010 provide the cooled medium 140 to the busbars 310-314, the terminals 220, 230, and/or the terminals 162 and 164 as a spray of liquid that covers the busbars 310-314, the terminals 220, 230, and/or the terminals 162 and 164. As illustrated in FIG. 11, the spray is actively vaporizing and the vaporizing spray of cooled medium 140 extracts heat from the busbars 310-314, the terminals 220, 230, and/or the terminals 162 and 164 and it is converted to a gaseous state, so the heated medium 150 may predominantly be a vapor of the medium. As illustrated, the heated medium is sucked from the cavity 610 by a second pump (not shown) via the outlet 114. A portion of the heated medium may pool in the cavity 610. Any portion of the heated medium 150 that remains in liquid form may be removed from the cavity 610 by a third pump (not shown). In this example embodiment, the busbars 310-314, the terminals 220, 230, and/or the terminals 162 and 164 are not submerged in the heated medium 150 in liquid form, but may be surrounded by the heated medium 150 in gas/vapor form.

Various implementations of heat removal systems 120 receives the heated medium 150 via the heated medium conduit 152 of the various implementations disclosed herein. The heat removal system 120 extracts heat from the heated medium 150 thereby decreasing the temperature of the heated medium (or condensing the heated medium if it is primarily a vapor). Once the temperature of the heated medium 150 has been reduced, it is referred to as cooled medium. The heat removal system 120 may use any of a wide variety of methods and systems for extracting heat from the heated medium 150 consistent with the type of medium used.

In a particular implementation, the heat removal system 120 includes a refrigeration system that removes heat from the heated medium 150 to produce the cooled medium 140 at a lower temperature than the heated medium 150. In another implementation, the HVAC system 120 includes a radiator that extracts heat from the heated medium 150 to produce the cooled medium 140 by passing the heat of the medium to another cooling medium to which the radiator is exposed.

In the various system implementations illustrated herein, the pump 130 receives the cooled medium from the heat removal system 120. The pump 130 provides the cooled medium 140 to the container 110 at a volume and a pressure sufficient for the cooling medium 140 to reduce or maintain the temperature of the battery cells 200 of the battery pack 160. As the temperature of the battery cells 200 in the battery pack 160 increases, the controller coupled with the heat removal system 120 may provide the cooled medium 140 at a lower temperature, at a higher pressure and/or in higher volume to maintain or reduce the temperature of the battery cells 200 of the battery pack 160.

As discussed above in the various implementations, the cooling system 100 may include one or more pumps for moving the cooled medium 140 and/or the heated medium 150. Regardless of the number of pumps, the cooling system 100 may be a closed system. Further, a processing circuit/controller may be used to coordinate the operation of the various pumps and the heat removal system 120 components as discussed herein.

The battery cells 200, the container 110, the HVAC system 120, the pump 130, the cooled medium conduit 142 and/or the heated medium conduit 152 may include temperature sensors for detecting the temperature to inform and/or control the operation of the heat removal system 120 and/or the pump 130. The processing circuit/controller may receive the information from the temperature sensors and use information to control the heat removal system 120 and/or the one or more pumps 130 and other system components.

In places where the description above refers to particular implementations of cooling systems and implementing components, sub-components, methods and sub-methods, it should be readily apparent that a number of modifications may be made without departing from the spirit thereof and that these implementations, implementing components, sub-components, methods and sub-methods may be applied to other cooling systems.

What is claimed is:

1. A cooling system for a battery pack, the system comprising:
a battery pack comprising a plurality of battery cells, each battery cell of the plurality of battery cells comprising an anode terminal and a cathode terminal;
at least two busbars coupled to the anode terminal and the cathode terminal of each battery cell of the plurality of battery cells to form one of a parallel connection between each battery cell of the plurality of battery cells or a serial connection between each battery cell of the plurality of battery cells;
a container enclosing only the anode terminal and the cathode terminal of each battery cell of the plurality of battery cells and the at least two busbars, the container forming a channel with an inlet and an outlet and the container sealed against exterior surfaces of the plurality of battery cells;
a tube passing through the container and comprising a plurality of openings spaced adjacent to the at least two busbars and spaced adjacent to one of the anode terminal, the cathode terminal, or both the anode terminal and the cathode terminal of each battery cell of the plurality of battery cells; and
a heat removal system in fluid communication with the tube.

2. The cooling system of claim 1, further comprising a pump in fluid communication with the tube and with the heat removal system.

3. The cooling system of claim 1, further comprising a medium cooled by the heat removal system and directed by the plurality of openings against the at least two busbars and the anode terminal and cathode terminal of each battery cell of the plurality of battery cells.

4. The cooling system of claim 3, wherein medium heated by the at least two busbars and the anode terminal and cathode terminal of each battery cell of the plurality of battery cells passes out of the outlet of the channel of the container to the heat removal system.

5. The cooling system of claim 1, wherein a controller is operably coupled with the battery pack and with the heat removal system.

6. The cooling system of claim 5, wherein when an activity of an electric vehicle associated with the battery pack is below a threshold, the controller does not activate the heat removal system.

7. The cooling system of claim 5, wherein when an activity of an electric vehicle associated with the battery pack is above a threshold, the controller activates the heat removal system.

8. A cooling system for a battery pack, the system comprising:
a battery pack comprising a plurality of battery cells, each battery cell of the plurality of battery cells comprising an anode terminal and a cathode terminal;
at least two busbars coupled to the anode terminal and the cathode terminal of each battery cell of the plurality of battery cells to form one of a parallel connection between each battery cell of the plurality of battery cells or a serial connection between each battery cell of the plurality of battery cells;
a container enclosing only the anode terminal and the cathode terminal of each battery cell of the plurality of battery cells and the at least two busbars, the container forming a channel with an inlet and an outlet, the container comprising a plurality of nozzles spaced adjacent to the at least two busbars and spaced adjacent to one of the anode terminal, the cathode terminal, or both the anode terminal and the cathode terminal of each battery cell of the plurality of battery cells;
a tube coupled to an exterior surface of the container and to the outlet of the container; and
a heat removal system in fluid communication with the tube.

9. The cooling system of claim 8, further comprising a pump in fluid communication with the tube and with the heat removal system.

10. The cooling system of claim 8, further comprising a medium cooled by the heat removal system and directed by the plurality of nozzles against the at least two busbars and the anode terminal and cathode terminal of each battery cell of the plurality of battery cells.

11. The cooling system of claim 10, wherein the medium is in two phases in the container.

12. The cooling system of claim 10, wherein the tube receives heated medium from the outlet of the container and directs it to the heat removal system.

13. The cooling system of claim 10, wherein the inlet of the container receives cooled medium from the heat removal system.

14. The cooling system of claim 8, wherein the nozzles are located on two or more sides of the container.

15. The cooling system of claim 8, wherein the nozzles are located on only one side of the container.

16. A method of cooling a battery pack, the method comprising:
providing a battery pack comprising a controller coupled with a plurality of battery cells, each battery cell of the plurality of battery cells comprising an anode terminal and a cathode terminal;
providing a container enclosing only the anode terminal and the cathode terminal of each battery cell of the plurality of battery cells, the container forming a channel with an inlet and an outlet and the container sealed against exterior surfaces of the plurality of battery cells;
monitoring an activity of an electric vehicle coupled with the battery pack using the controller;
when the activity of the electrical vehicle is below a first threshold, the controller does not activate a heat removal system in fluid communication with the container;
when the activity of the electrical vehicle is above the first threshold but below a second threshold, the controller activates the heat removal system in a low throughput mode; and
when the activity of the electrical vehicle is above the second threshold, the controller activates the heat removal system in a high throughput mode.

17. The method of claim 16, further comprising a medium cooled by the heat removal system.

18. The method of claim 17, wherein when the activity of the electrical vehicle is below the first threshold, the medium passively flows in the container.

19. The method of claim 17, further comprising a pump in fluid communication with the container and with the heat removal system.

20. The method of claim 19, further comprising when the activity of the electrical vehicle is below a first threshold, the controller does not activate the pump;
when the activity of the electrical vehicle is above the first threshold but below a second threshold, the controller activates the pump in a low throughput mode; and
when the activity of the electrical vehicle is above the second threshold, the controller activates the pump a high throughput mode.
